(19) United States
(12) Patent Application Publication
(10) Pub. No.: US 2015/0202790 A1
(43) Pub. Date: Jul. 23, 2015

(54) METHOD AND DEVICE FOR REPAIRING PLYWOOD PANEL DEFECTS

(71) Applicant: Martco Limited Partnership, Alexandria, LA (US)

(72) Inventors: Allan Patterson, Alexandria, LA (US); Barry Bertus, Alexandria, LA (US)

(21) Appl. No.: 14/594,951

(22) Filed: Jan. 12, 2015

Related U.S. Application Data
(60) Provisional application No. 61/930,888, filed on Jan. 23, 2014.

(51) Int. Cl. B27G 1/00; B05C 5/00; B05D 7/06

(52) U.S. Cl. CPC B27G 1/00; B05D 7/06; B05C 5/001

(57) ABSTRACT

The present invention is directed to a synthetic patch application method and device in which synthetic patching material is kept cool while it is mixed in a static mixing tube, prior to application to plywood panels. The synthetic patching material is kept cool by means of a removable cooling jacket that is installed to remove the exothermic heat of reaction generated during the mixing process. The cooling jacket is removable and reusable, and may be easily dismounted and remounted when replacement, adjustment, or repair of the static mixing tube is necessary. The present invention thus provides an improved method of repairing plywood panels using thermosetting resin-based synthetic patching materials in which waste is minimized and time between replacement of static mixing tubes is significantly extended.

### CROSS REFERENCE TO RELATED APPLICATION

This application claims the benefit of U.S. Provisional Application No. 61/930,888, filed Jan. 23, 2014, the entire content of which is hereby incorporated into by reference.

### BACKGROUND OF THE INVENTION

The present invention relates to a method and system for continuously applying synthetic plywood patching material to mend knot holes, chips, cracks and other defects which appear on the surface of a wood plate such as a veneer or a plywood panel.

Plywood panels are formed from a plurality of layers of thin sheets of wood veneer adhered to one another, each with its wood grain rotated relative to adjacent layers (up to 90 degrees) for increased strength and dimensional stability. Generally, the veneer is peeled or sliced from a log, dried, then prepared to eliminate defects such as knot holes, chips, cracks, and the like. To form the plywood, the prepared veneer layers are piled on top of on one another with appropriate adhesives disposed between them. These veneer layers are then pressed together under appropriate conditions of heat and pressure to form a substantially integral plywood panel structure. The panel may be cut into smaller panels of appropriate size, and any remaining defects may be routed and/or patched. The panel then may be sanded and subjected to a quality control inspection. Panels that are still deemed defective may be returned to the routing and patching stations or to the sanding station to assure that necessary quality control is achieved. The completed panels then are appropriately packaged and shipped.

In a plywood mill, the patching process is usually performed manually based upon the visual appearance of the panels as perceived by inspectors or detected by automatic inspection devices. Typically, completed panels having defects are laid on a conveyor belt being monitored by one or more inspectors or inspection devices tasked with locating and taking action to correct any observed panel defects. This conveyor belt is also known as a “patch line.” When a defect is detected, patching material is deposited on the defect in order to fill up the defect of the veneer, and this is performed while the panel is in motion on the conveyor belt. The conveyor is then driven to transport the patched veneer in the direction toward rollers, presses, steel belts or other plywood finishing devices, which compress and smooth out the veneer and patch in the thickness-wise direction such that the surface of the panel is level and free of splinters or excess patching compound. The panel then may be passed to one or more arrays of radial saws to edge trim the panel, and/or to cut the panel into a plurality of smaller panels. The panel then is advanced to appropriate locations for stacking and shipping.

Plywood panel defect removal, i.e., patching, is generally carried out using synthetic patch materials to fill defects in the panels such that they meet the limits permitted by the desired plywood standards. Such defects may include open knot holes, splits, holes made by worms or insects, pitch pockets, bark pockets, veneer roughness, chipped or solid knots, lathe marks, veneer shelling, impressions and splits and tears caused by handling or transport of the panels. Smooth, durable panel surfaces may only be produced if the plywood panel surface veneer is smooth and free of defects. Surface variations as small as thousandths of an inch may result in areas of low pressure which compromise the strength and durability of the plywood. It is therefore important to repair naturally-occurring or man-made veneer surface defects during plywood manufacture.

The use of synthetic patch material complicates and limits the continuity of the patching process, as synthetic patch material is typically made up two components: (1) a solid, semisolid, or pseudosolid thermosetting resin and (2) catalytic material for hardening the resin. The resin is pumped through a heated line to lower its viscosity so that it may soften and flow smoothly during application to plywood panels using a dispensing unit, such as a patch gun. Prior to being applied to the panel, the resin is mixed with the catalytic material in a static mixing tube. The mixed resin/catalyst combination is dispensed directly onto the plywood panel defect to fill in and cover the defect. As described above, the patched plywood continues along the conveyor belt and correction of the defect is complete once the resin and plywood surface have been smoothed over.

A major problem faced during the plywood patching process is hardening of the patching material in the mixing tube before it is dispensed. For example, at an ambient temperature of approximately 95 degrees Fahrenheit, a commonly used resin with an upstream heated line temperature of 125 degrees Fahrenheit will harden and destroy a brand new mixing tube if not dispensed from the tube within about eight seconds. This occurs because the catalytic hardening of the resin/catalyst mixture is a chemical reaction, the speed of which increases in the presence of heat. Due to the presence of heat in the mixing tube, there is a high risk of the resin/catalyst mixture hardening or setting before leaving the mixing tube, and thus the patch mixture must be forced out and applied to a plywood panel within seconds of being mixed.

Hardening of the synthetic patching material within the mixing tube can damage and decrease the lifespan of the mixing tube, which is costly and time-consuming to replace, and especially disruptive during operation of the patch line. Hardening of the synthetic patching material within the mixing tube can be avoided when the patching process is semi-continuous, i.e., the resin/catalyst mixture is dispensed at sufficiently short intervals, such that the mixture does not spend enough time within the mixing tube to set therein. However, unforeseen delays or skips on the patch line, pauses due to variations in plywood grade requirements, as well as other discontinuities and breaks in the patching process are inevitable. In the past, when such discontinuities occurred, the operator of the patch dispenser would simply dispense the rapidly-hardening synthetic patch material into a waste container until the patch line was running again, which prevented unused patch from setting in the mixing tube. Though this is less wasteful and time consuming than replacing a ruined mixing tube each time there is a delay on the line, such waste of patching material still carries significant costs. Moreover, it is often the case that patch has already begun to harden within the mixing tube before the excess patch has been discharged, which reduces the effectiveness of the mixing tube and shortens its useable life. Thus, there is a need to extend the time the resin/catalyst mix can spend in the mixing tube without setting in the mixing tube, thereby reducing unnecessary waste in the plywood manufacturing process and preventing damage to patch dispensing equipment.

### SUMMARY OF THE INVENTION

The present invention provides a compact, easy-to-use system for continuously applying synthetic polymeric patching material to repair plywood panel defects on a patch line. The system may be easily assembled and dismantled whenever replacement of individual parts is necessary. The plywood panel defects which may be repaired by this system include open knot holes, splits, holes made by worms or insects, pitch pockets, bark pockets, veneer roughness, chipped or solid knots, lathe marks, veneer shelling, and impressions, splits or tears caused by handling or transport of the plywood panels, among other defects. The present invention also provides a method for using such a system.

More specifically, the present invention is directed to a synthetic patch application device and method in which synthetic patching material is kept cool while it is mixed in a mixing vessel, such as a static mixing tube, prior to application to plywood panels. The synthetic patching material is kept cool by means of a removable cooling jacket which contains circulating cooling medium which flows from a reservoir, throughout the jacket, then back though the reservoir. Such a cooling jacket is installed to remove the exothermic heat of reaction generated during the mixing process. The cooling jacket is removable and reusable, and may be easily dismounted and remounted during replacement of the mixing vessel. The present invention thus provides an improved method of repairing plywood panels using thermosetting resin-based synthetic patching materials, in which waste of synthetic patching material is minimized, the quality and effectiveness of mixing tubes is preserved, and time between replacement of static mixing tubes is significantly extended.

The method utilizing the invention described above includes the steps of mixing heated resin with a catalytic material in a static mixing tube to form a synthetic patching material which may be continuously applied to plywood panel defects as defective plywood panels are conveyed along a plywood repair line, and extending the operating life of the static mixing tube by cooling the mixing tube to increase the setting time of the patching material so that the patching material either does not set, solidify, or block the mixing tube or need to be discharged during periods of interruption or non-use of a continuous plywood defect repair method.

In particular, the invention provides a method for continuously applying polymeric patching material to repair plywood panel defects after mixing heated resin and catalyst components in a static mixing tube to form the patching material. This method extends the operating life of the static mixing tube by cooling the mixing tube to increase the setting time of the patching material so that the patching material either does not set, solidify, or block the mixing tube or need to be discharged during periods of interruption or non-use of the continuous plywood defect repair method. The operating life of the static mixing tube is extended by delaying the setting time of the patching material by up to about 5 to 10 times longer than it would be when applied from an uncooled static mixing tube.

More specifically, the cooling of the static mixing tube increases the setting time of the patch material from about 8 seconds to about 60 seconds. Thus, when the resin is heated to a temperature of 100 to 150 degrees Fahrenheit before entering the mixing tube, the static mixing tube can be cooled to a temperature of 70 to 120 degrees Fahrenheit by the inventive cooling jacket. To achieve this, the mixing tube is cooled by contact with a chilled liquid that has a temperature of about 50 to 60 degrees Fahrenheit. This cooling of the mixing tube increases the time period between replacement from about 20 to 60 minutes.

The invention also relates to a device for extending the operating life of a polymeric patching material formed by mixing resin and catalyst components in a mixing tube where the resin has been heated to reduce its viscosity prior to entering the mixing tube. The device includes a jacket provided around the mixing tube and defined by an outer wall spaced from the mixing tube, an inlet for introducing chilled liquid into the jacket for contacting the mixing tube, and an outlet for discharging liquid from the jacket, wherein the chilled liquid cools the static mixing tube to increase the setting time of the patch material so that the patch material either does not set solidify and block the mixing tube or need to be discharged during periods of interruption or non-use of the mixing tube.

For convenient installation, the device utilizes compression nuts and sleeves associated with each end of the jacket for rapid mounting of the jacket upon the static mixing tube. The compression nuts are preferably made of a metal such as brass while the compression sleeves are made of an engineering plastic. The jacket may sealed to the mixing tube by elastomeric O-rings to facilitate easy assembly and disassembly. For this, the jacket may be made of an aluminum or plastic tube that is reusable when the static mixing tube is replaced.

Alternatively, the inlet and outlet are mounted on the same end of the jacket near an inlet of the mixing tube. In this embodiment, the jacket comprises concentric inner and outer tubes having first and second ends, with the inner tube including the outer wall. These tubes are constructed to direct liquid to flow from the first end to the second end of the inner tube that is adjacent to and contacting the static mixing tube to the second end and then to flow back from the second end to the first end through the outer tube that surrounds the inner tube. Thus, the liquid entry and discharge are located at the same end of the device to balance the device to facilitate handling and use.

The invention also relates to various combinations of the cooling devices disclosed herein in combination with various static mixing tubes. This results in system for extending the operating life of a polymeric patching material formed by the mixing of the resin and catalyst components in a static mixing tube where the resin has been heated to reduce its viscosity prior to entering the mixing tube. The system includes and is operatively associated with a reservoir of chilled liquid and a pump for directing chilled water to the jacket, with the chilled liquid cooling the static mixing tube to increase the setting time of the patch material. The pump is typically submersed in the reservoir from which the cooling water is obtained and supplied to the jacket. After contacting and cooling the mixing tube, the warmed water is returned to the reservoir for cooling to the desired temperature prior to being reused and recycled back to the jacket. This reduces and minimizes water usage, as compared to a system in which the warmed water would be discarded or discharged.

Finally, another embodiment of the invention is the combination of the cooling jacket and static mixing tube which is available as a replacement component.

### BRIEF DESCRIPTION OF THE DRAWINGS

Preferred and non-limiting features of the invention will now be described in connection the appended drawing figures, wherein:

FIG. 1 is a length-wise cross-sectional view of one embodiment of a continuous patch application system according to the present invention, in which the cooling medium enters and exits at opposite ends of cooling sleeve.

FIG. 2 is a length-wise cross-sectional view of one embodiment of a continuous patch application system according to the present invention, in which the cooling medium enters and exits at the same end of the cooling sleeve.

FIG. 2A is an exploded view of the system of FIG. 2.

FIG. 3 is a width-wise cross-sectional view of the embodiment shown in FIG. 2.

FIG. 4 shows a variation of the configuration of the components shown in FIG. 3.

### DETAILED DESCRIPTION OF THE PREFERRED EMBODIMENTS

It should be borne in mind that in all the embodiments which will be described, the terms “plywood” and “plywood panel” refer generally to any type of wood plate, including plywood, veneers, sawed plates, and the like. The terms “mixing vessel” and “mixing tube” may also refer to any device which effectuates mixing between multiple components of a plywood patching material. For convenience, the following description will be made assuming a plywood panel as the wood plate needing repair and a two-component synthetic patch as the patching material to be used.

Typically, systems used to continuously patch plywood with synthetic patching material include at least one metering unit and one dispensing unit per patch line. The synthetic patching material used generally comprises two components: (1) a solid, semisolid, or pseudosolid thermosetting resin and (2) catalytic material for hardening the resin. The separate components of the synthetic patching material are contained in large storage totes, which are connected to pneumatic pumps used to pump the components from the totes to a metering device. Each metering device regulates the flow of the synthetic patching material components in order to achieve the desired ratio between the components in the final synthetic patch mixture that will be applied to the plywood panel defect.

A dispensing unit is attached to each metering device to combine the components into a two-part mixture, metered to the desired ratio of resin to catalyst, and mixed together in a mixing vessel, such as a static mixing tube. The high pressure of the material flowing from the dispensing unit into the inlet of the static mixing tube forces the materials that are concurrently flowing within the tube to move continuously through the tube, rapidly forming a homogeneous mixture that is ready to be deposited onto the defective surface of a plywood panel on the patch line. The outlet of the mixing tube is positioned over the defect of the plywood panel, and the homogeneous mixture of resin and catalyst components is then forcibly discharged through the outlet of the mixing tube in order to be deposited onto the plywood panel defect.

In general, the setting time for any given synthetic patch material depends upon the components of the patch material, ambient temperature, heated resin line temperature, and plywood panel temperature. The device and method of the present invention incorporate an outer cooling jacket or sleeve which completely surrounds and is concentric with at least a portion of the static mixing tube. A cooling medium, such as chilled water, flows from a reservoir, into and through the cooling jacket, then back to the reservoir to remove heat from the mixing tube in order to prevent the resin/catalyst mixture from setting within the mixing tube prior to being deposited onto a plywood panel defect. The flow of cooling medium is maintained through a submersible pump located inside of the reservoir. The resin catalyst mixture travels through the mixing tube as normal, while the cooling medium travels through the outer jacket. On a straight static mixing tube, the jacket usually extends almost to the end of the pipe, leaving some room to introduce and affix the necessary seals to prevent the cooling medium from leaking from the jacket.

The advantages of jacketing the mixing tube are that jacketing allows for constant and steady heat removal from the mixing tube and ensures more even distribution of heat throughout the mixing tube. This slows down the catalytic hardening of the synthetic patch material within the mixing tube, maintaining the patch material at a viscosity at which it may be smoothly discharged onto a defective plywood panel moving along the patch line. The cooling jacket also reduces the danger of localized hot spots, which can cause localized expansion or other damage to the inside surfaces of the mixing tube, both of which can lead to disruptions of the patching process and excess costs due to increased frequency of mixing tube replacement and/or repair. Jacketing has the added benefit of allowing for predictable and steady outlet temperature of the patch material, as the temperature of the mixing tube can be controlled by adjusting the temperature and flow rate of the cooling medium flowing through the jacket. Ultimately, a lower temperature of the patch material within the mixing tube increases flexibility on the patch line, as a lower temperature extends the set time of the patch material.

Jackets can be applied to the entire surface of a mixing vessel or just a portion of it, and they can also be divided into zones to divide the flow of the cooling medium along the mixing vessel. Various jacket configurations provide the ability to direct flow to certain portions of the jacket, such as only the bottom head when minimal cooling is needed, or the entire jacket when maximum cooling is required. Various cooling mediums may be used, such as chilled water, antifreeze blends, or cold air/inert gas, depending on the heat removal requirements of the system.

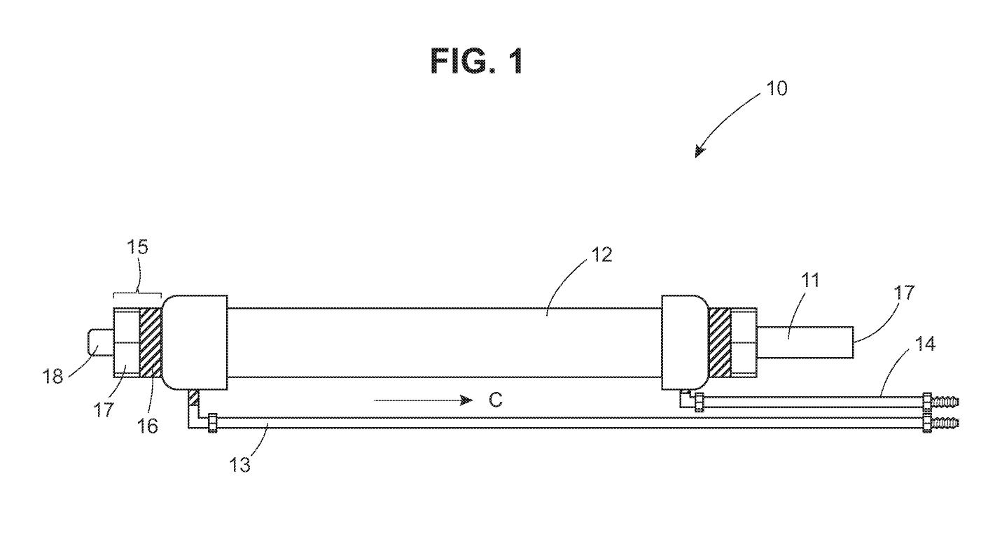

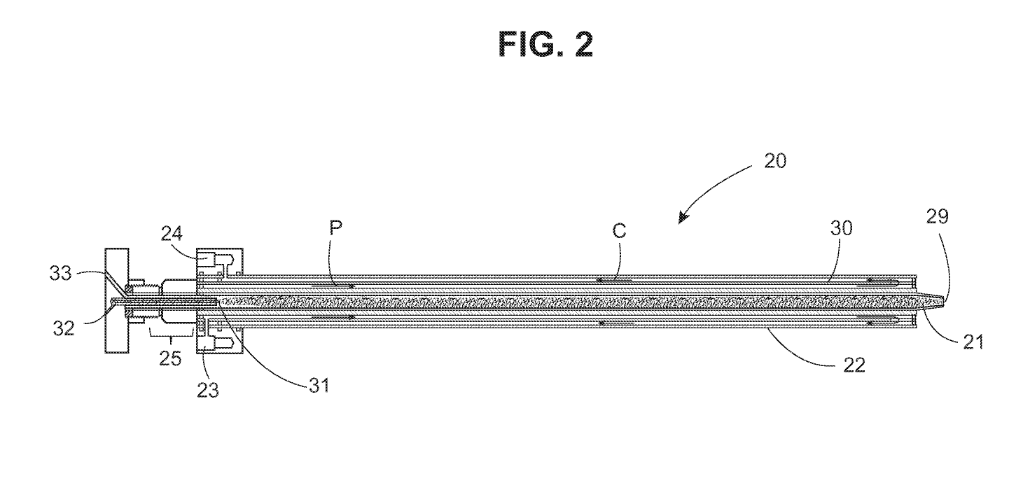

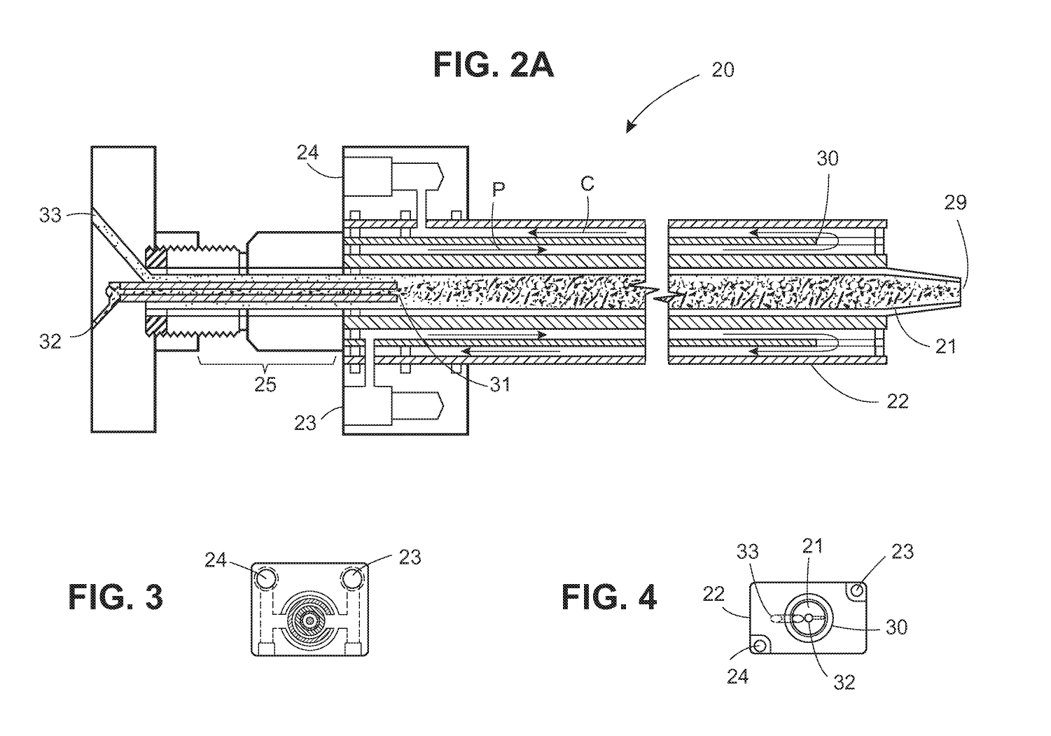

Referring now to the figures, wherein like numbers represent like elements, FIGS. 1 and 2 show length-wise cross-sectional views of two embodiments of the present invention. FIG. 1 is a length-wise cross-sectional view of one embodiment of a continuous patch application system for the repair of plywood panel defects having a cooling jacket, wherein the cooling medium enters and exits at opposite ends of the cooling jacket. FIG. 2 is a length-wise cross sectional view of another embodiment of a continuous patch application system for the repair of plywood panel defects having a cooling jacket, in which the cooling liquid enters and exits at the same end of the cooling jacket.

In FIG. 1, there is illustrated an embodiment of a system for continuously applying synthetic plywood patching material 10 comprising a static mixing tube 11, a cooling jacket 12, a cooling medium inlet tube 13, a cooling medium outlet tube 14, and compression fittings 15. The static mixing tube 11 has a patching material inlet 17 and a patching material outlet 18. Heated resin and reaction catalyst enter at high pressure through the patching material inlet 17 to be mixed in the static mixing tube 11 and, once thoroughly mixed, the homogeneous mixture of resin and catalyst exit through the patching material outlet 18 to be deposited on a plywood panel moving along a patch line. As patching material is mixed and moves through the static mixing tube 11 from one end to the other, cooling medium is continuously circulated throughout the cooling jacket, moving from the cooling medium inlet tube 13 to the cooling medium outlet tube 14. Although the embodiment presented in the figure shows the cooling medium flowing in the direction counter (direction C) to the flow of patching material through the mixing tube 11, it is possible to achieve a similar cooling effect when the cooling medium flows through the cooling jacket 12 in the same direction as, or parallel to, the flow of patching material from one end of the mixing tube 11 to the other.

The static mixing tube 11 is typically made of conductive materials, such as aluminum, to assist in heat transfer from the patch material to the cooling medium. The cooling jacket 12 may be made of a wide range of materials having varying properties (such as PVC or aluminum), with the choice of material depending upon the desired amount of heat transfer between the cooling medium and the ambient air or surroundings. The cooling medium inlet and outlets tubes 13,14 may be flexible or inflexible, depending on the requirements of the system, and their material compositions may vary depending on the insulation requirements for maintaining the required amount of heat transfer between the cooling medium and the external environment of the manufacturing zone. The compression fittings 15 are typically comprised of compression sleeves 16 and compression nuts 17. The compression sleeves are made a suitable compressible material, often an engineering plastic such as Delrin, while the compression nuts are made of a harder or stronger material, such as brass, steel or other metals. When a nut 17 is tightened and the adjacent sleeve 16 is compressed between the nut 17 and the adjacent end of the cooling jacket 12, the space between the mixing tube 11, nut 17, and cooling jacket 12 is sealed, preventing the escape of any cooling medium through the seams formed between the mixing tube 11 and cooling jacket 12. Such compression fittings 15 may be formed using any materials capable of maintaining a seal between the cooling jacket 12 and the mixing tube 11 such that the cooling medium does not escape during circulation.

In addition to preventing damage to mixing tubes 11 and reducing the amount of wasted patch material, a major advantage of the present invention is the ease with which the compression fittings 15 may be removed and the cooling jacket 12 slid off of the static mixing tube 11. Because the cooling jacket 12 and its associated components (compression fittings 15 and cooling medium inlet and outlets tubes 13,14) may be removed and reapplied quickly and easily, there is very little downtime associated with replacement of expired or otherwise damaged mixing tubes 11. Thus, overall, the presently claimed system is a time- and cost-saving addition to any continuous synthetic patch application process, as it reduces both the frequency of and total time required for replacement of mixing tubes 11 over the long-run.

In FIGS. 2 and 2A, there is illustrated another embodiment of a system for continuously applying synthetic plywood patching material 20 comprising a static mixing tube 21, a cooling jacket 22, a cooling medium inlet 23, a cooling medium outlet 24, and compression fittings 25. The static mixing tube 21 has a resin inlet 27, a catalyst inlet 28, and a patching material outlet 29. Heated resin and reaction catalyst enter through their respective inlets 27, 28 at high pressure to be mixed in the static mixing tube 21 and, once thoroughly mixed, the homogeneous mixture of resin and catalyst exit through the patching material outlet 29 in order to be deposited on a plywood panel moving along a patch line.

One significant difference between the embodiment shown in FIG. 2 and the embodiment shown in FIG. 1 and that of FIGS. 2 and 2A is that the catalyst is fed into the mixing tube at catalyst inlet 32 and resin is fed into the mixing tube at location 33, such that the catalyst is not combined with the resin until it reaches location 31, significantly farther along the length of the mixing tube and closer to the patching material outlet 29. This configuration shortens the amount of time the resin and catalyst spend mixing together within the static mixing tube 21 and reduces the potential for the resin/catalyst mixture to set within the mixing tube 21 prior to being dispensed. As patching material is mixed and moves through the static mixing tube 21 from one end to the other, cooling medium is continuously circulated throughout the cooling jacket 22, moving from the cooling medium inlet 23 to the cooling medium outlet 24. In this embodiment, however, the cooling jacket 22 further includes a concentric tube 30 which is situated between the mixing tube 21 and the cooling jacket 22. Cooling medium flows both parallel (direction P) and counter (direction C) to the flow of patching material through the mixing tube 21, as shown in FIGS. 2 and 2A. Cooling medium entering the cooling jacket 22 through cooling medium inlet 23 flows parallel to the entering patch material components, adjacent to the static mixing tube 21 along the entire length of the cooling jacket 22, then reverses direction to flow in the space between the concentric tube 30 and the cooling jacket 22, then exits through the cooling medium outlet 24.

The system of the present invention may further include an automatic detection device to locate, and, optionally, correct plywood panel defects as plywood panels move along a patch line. Such defect detection may be performed electro-optical defect scanners, blow detection systems, or other automatic defect detection device. Once a defect has been detected by the automatic detection device, a computerized system may be used to direct the plywood patch dispensing unit to the location of the defect to fill in and cover the defect, and subsequently finish the plywood panel such that it is in accordance with the desired plywood standards. Such a process may be effectuated through the use of robotic mechanisms and equipment in conjunction with sensors and/or automatic inspection devices along the patch line. A suitable system is disclosed in U.S. Pat. No. 4,984,172, the entire content of which is expressly incorporated herein by reference thereto. The plugging devices illustrated in that patent can be modified to include cooling jacket of the type disclosed herein to achieve processing benefits regarding the reduction of wasted patch material when the line is not operating during intermittent periods of interruption or non-use.

In addition, the combination of the cooling jacket and static mixing tube represents another embodiment of the invention. In this embodiment, the cooling jacket mixing tube can be made as a unitary component which can be replaced as necessary after the tube life is exhausted. As can be appreciated, even with the invention, the tube life is not infinite and provision of a combined cooling jacket/mixing tube can simplify the replacement process and reduce the time for changing those components when necessary to do so.

### EXAMPLE

An aluminum cooling jacket having an outer diameter of 0.850 inches was mounted on a 16-inch aluminum static mixing tube having an outer diameter of 0.3125 inches. A compression fitting having an outer diameter of 0.3125 inches was embedded on each side of the cooling jacket, forming a watertight seal between the cooling jacket and the mixing tube. A standard pipe gun was affixed at one end of the mixing tube. The pipe gun was connected to a metering device to combine a two-component ambient temperature cured polyurethane resin system (CU-100 Synthetic Patch, manufactured by Willamette Valley Company, metered to a 6:1 resin-to-catalyst ratio, which has a setting time of 45 seconds at 77 degrees Fahrenheit. Chilled water at 55 degrees Fahrenheit was circulated from a 12 gallon reservoir to the cooling jacket and back, with the water flowing counter to the flow of the synthetic patch mixture through the mixing tube. The plywood panel temperature was 175 degrees Fahrenheit, the heated resin line temperature was 120 degrees Fahrenheit, and the ambient temperature was 95 degrees Fahrenheit. Under these conditions, the following data was observed:

(1) Under semi-constant use with the cooling jacket running, the discharge temperature of the patching material from the mixing tube was 107 degrees Fahrenheit, and the setting time of the patch material was 16 seconds.

(2) After a 45 second hold of the patch material within the mixing tube with the cooling jacket running, the discharge temperature of the patch material was 71 degrees Fahrenheit, and the setting time of the patch material increased to 34 seconds.

(3) Under standard application (i.e., without use of the cooling jacket), the discharge temperature of the patch material was 122 degrees Fahrenheit, and the setting time of the patch material decreased to 13 seconds.

While there has been shown and described what are considered to be preferred embodiments of the invention, it will of course be understood that various modifications and changes in form or detail could readily be made without departing from the spirit of the invention. It is therefore intended that the invention not be limited to the exact form and detail herein shown and described, nor to anything less than the true spirit and scope of the invention as hereinafter claimed.

What is claimed is:

1. A method for continuously applying polymeric patching material to repair plywood panel defects after mixing heated resin and catalyst components in a static mixing tube to form the patching material, comprising extending the operating life of the static mixing tube by cooling the mixing tube to increase the setting time of the patching material so that the patching material either does not set, solidify, or block the mixing tube or need to be discharged during periods of interruption or non-use of the continuous plywood defect repair method.

2. The method of claim 1 wherein the operating life of the static mixing tube is extended by delaying the setting time of the patching material by 5 to 10 times as long as it would be in an uncooled static mixing tube.

3. The method of claim 2 wherein the static mixing tube is cooled to increase the setting time of the patch material from about 8 seconds to about 60 seconds.

4. The method of claim 1 wherein the resin is heated to a temperature of 100 to 150 degrees Fahrenheit before entering the mixing tube and the static mixing tube is cooled to a temperature of 70 to 120 degrees Fahrenheit.

5. The method of claim 4 wherein the mixing tube is cooled by contact with a chilled liquid that has a temperature of about 50 to 60 degrees Fahrenheit.

6. The method of claim 1 wherein the cooling of the mixing to increases its time period for replacement from about 30 to 60 minutes.

7. A device for extending the operating life of a polymeric patching material formed by mixing resin and catalyst components in a mixing tube where the resin has been heated to reduce its viscosity prior to entering the mixing tube, comprising a jacket provided around the mixing tube and defined by an outer wall spaced from the mixing tube, an inlet for introducing chilled liquid into the jacket for contacting the mixing tube, and an outlet for discharging liquid from the jacket, wherein the chilled liquid cools the static mixing tube to increase the setting time of the patch material so that the patch material either does not set solidify and block the mixing tube or need to be discharged during periods of interruption or non-use of the mixing tube.

8. The device of claim 7 further comprising compression nuts and sleeves associated with each end of the jacket for rapid mounting of the jacket upon the static mixing tube.

9. The device of claim 7, wherein the compression nuts are made of metal while the compression sleeves are made of an engineering plastic, and the jacket is made of an aluminum or plastic tube that is reusable when the static mixing tube is replaced.

10. The device of claim 7 wherein the jacket comprises an aluminum or plastic tube that is reusable when the static mixing tube is replaced.

11. The device of claim 10 wherein the inlet and outlet are mounted on the same end of the jacket and near an inlet of the mixing tube and the jacket comprises concentric inner and outer tubes having first and second ends, with the inner tube including the outer wall and with the tubes constructed to direct liquid to flow from the first end to the second end of the inner tube and then through the outer tube from the second end back to the first end.

12. The device of claim 11, wherein the jacket is sealed to the mixing tube by elastomeric O-rings.

13. A combination comprising the device of claim 7 and a static mixing tube that receives resin and catalyst components for mixing therein.

14. A system for extending the operating life of a polymeric patching material formed by mixing resin and catalyst components in a static mixing tube where the resin has been heated to reduce its viscosity prior to entering the mixing tube, comprising:
the device of claim 7;
a reservoir of chilled liquid; and
a pump for directing chilled water to the jacket;
wherein the chilled liquid cools the static mixing tube to increase the setting time of the patch material.

15. The system of claim 14, wherein the pump is submersed in the reservoir.

16. The system of claim 14, wherein the system further includes a static mixing tube that receives resin and catalyst components for mixing therein.
